(19) United States
(12) Patent Application Publication
(10) Pub. No.: US 2013/0273486 A1
(43) Pub. Date: Oct. 17, 2013

(54) LAYER FURNACE SYSTEM AND METHOD FOR OPERATING THE LAYER FURNACE SYSTEM

(71) Applicant: BENTELER AUTOMOBILTECHNIK, GMBH, Paderborn (DE)

(72) Inventors: Borek Dvorak, Jablonec nad Nisou- Rynovice (CZ); Radovan Kout, Liberec (CZ)

(73) Assignee: Benteler Automobiltechnik, GmbH, Paderborn (DE)

(21) Appl. No.: 13/862,914

(22) Filed: Apr. 15, 2013

(30) Foreign Application Priority Data
Apr. 16, 2012 (DE) 10 2012 103 275.0

(51) Int. Cl. F27D 7/00

(52) U.S. Cl. CPC F27D 7/00
USPC 432/9; 432/120

(57) ABSTRACT

A layer furnace system for thermal treatment of metal components includes multiple heating levels which arranged on top of each other in vertical direction, and at least one heat source, wherein flat metal components, in particular metal sheets can be inserted into the heat levels and at last one heating level can be closed by a furnace door, wherein the furnace door is can be displaced in vertical direction for opening and closing the heat level located there behind. The present invention also relates to a method for operating the layer furnace system.

### CROSS-REFERENCES TO RELATED APPLICATIONS

This application claims the priority of German Patent Application, Serial No. 10 2012 103 275.0, filed Apr. 16, 2012, pursuant to 35 U.S.C. 119(a)-(d), the content(s) of which is/are incorporated herein by reference in its entirety as if fully set forth herein.

### BACKGROUND OF THE INVENTION

The present invention relates to a layer furnace system and to a method for operating the layer furnace system.

The following discussion of related art is provided to assist the reader in understanding the advantages of the invention, and is not to be construed as an admission that this related art is prior art to this invention.

From the state of the art, layer furnace systems are known, for heating in particular steel plates. For this, steel plates i.e., flat metal components which can have dimensions of a few square centimeters up to several square meters, are introduced into the layer furnace system.

Such a layer furnace system is known for example from DE 10 2006 020 781 B3.

The layer furnace systems consist of multiple furnace levels stacked on top of one another into which the metal components are then inserted. In order to minimize heat loss or to reach the predetermined temperatures per furnace level, each of the furnace levels has a furnace door or furnace hatch.

The furnace doors are known from the state of the art as pivotal furnace door or as a lateral sliding element. In case of a pivotal furnace door, a pivot axis is arranged above or below the furnace door, so that the furnace door can be pivoted as furnace lid about the pivot axis, thereby providing access to a heating level located behind the furnace door. On one hand, such a furnace lid has the disadvantage that the distance of the individual heating levels to each other is in part defined by the lid mechanics, and on the other hand that a corresponding mechanics has to take different thermal expansions into account with regard to the pivot axis in order to ensure a proper functioning in different heating stages of the furnace. Even then, wear or malfunctions sometimes occur in such furnace systems during operation.

Furnaces which have a slider require more space so that the slider can be slid open sideways to the furnace to enable access to the heating level there behind. Further, in the case of heating levels which are capable of receiving sheets of several meters in size, a sliding lid is up to 3, 4 or even 5 meters long. The sideways movement of such a sliding lid thus requires a corresponding mechanics because the sliding lid itself thermally heats up as well.

Common to both previously mentioned lid systems in the aforementioned furnace door systems is that in the case of maintenance or repair, only limited access to the furnace located there behind is possible.

It would therefore be desirable and advantageous to provide a layer furnace system which can be operated easily.

### SUMMARY OF THE INVENTION

According to one aspect of the present invention, a layer furnace system for thermally treating metal components has multiple heating levels stacked atop one another and at least one heat source, wherein flat metal components, in particular metal sheets can be introduced into the heating levels and each level can be closed by a furnace door. According to the invention, the level furnace system is characterized in that the at least one furnace door for opening and closing of the heating level located there behind can be shifted in vertical direction.

According to another advantageous feature of the present invention, the layer furnace system is constructed as a tower furnace or a level-furnace in which multiple heating levels are arranged so as to be stacked on top of each another, for example also a multi-layer furnace system. The heating levels can for example be separated from one another by separator grids or by separation elements.

The layer furnace system is heated via at least one heat source. The heat source can for example be an electric heat source or a furnace heat source for example a gas burner. Within the framework of the invention, multiple heat sources can also be arranged, for example each heat level or every two neighboring heat levels can be assigned a heat source so that an even and homogenous temperature distribution is established in the individual heat levels or alternatively the temperature in each heat level is separately adjustable.

With the layer furnace system according to the invention, it is possible to thermally treat, in particular heat, metal components which are in particular configured flat, particularly preferably as metal sheets. For this, the heat the layer furnace system can be used to heat to for a few minutes up to several hours or days. The metal components can be heated in the furnace system to a temperature above room temperature for example 50° C. and above, or to a temperature above AC3-temperature of steel components. Thus, the metal components can be heated to temperatures of up to 1.100° C. or up to 1.200° C. It is thus possible to thermally treat steel components, but also light metal components.

According to another advantageous feature of the present invention, the layer furnace system includes at least two vertically oriented columns, in particular four vertically oriented columns, wherein the columns serve as holders, and individual heating levels can be stacked on top of one another, wherein a respective heat source can be arranged between the heat levels. Stacking the heating levels on top of each other makes it possible to modularly construct the layer furnace system in accordance to the respective situation. For example, only two or three heating levels may be provided by stacking separation elements atop one another, however it is also possible to stack 10, 20 or even 30 heating levels on top of one another. Preferably, the individual heating levels are configured as box-shaped elements, which in particular are open to the front side and/or rear side, wherein the box-shaped elements are then stackable on top of one another and each forms a single heating level in its respective interior. It is then possible to arrange heat sources in between the heating levels or on the side or in front of or behind the heating levels to affect a heat action on the components that are located in the heating levels. The heating levels can also be formed by stacking separation elements on top of each other, wherein in this case a heating level is formed between each two respective separation elements. It is then possible to either arrange a heat source between two separation elements which then enables a heat action on the spaces neighboring the separation elements, i.e. the heating levels or to arrange a heat source between the separation elements which correspondingly heats the heating level which at the same time is located between the separation elements.

A respective heat source can then be arranged between the separation elements again in modular fashion, so that different temperatures can be established in the individual heating levels. For example, the heat source can heat directly neighboring heating levels to a higher temperature than the second or third nearest heating levels.

In case of a defect in a separation element, a furnace door or a heat source, it is again possible to lift the separation elements by means of a crane individually or in modular fashion, in particular together with the units located there above thereby creating sufficient access in form of a maintenance or repair space, for example on the defective heat source. When the repair is complete, the lifted separation elements can be lowered again together with the heat levels contained therein and operation of the layer furnace system can be continued. Within the framework of the invention, it is particularly advantageous that when lifting a defective unit the unit located there above is lifted along. For example, if in a layer furnace consisting of ten heating levels the second heating level from the bottom is defective, the first to eight heating levels can be lifted in order to reach and repair the ninth heating level located there underneath. Subsequent lowering of the eight heating level, also causes the first and seventh heating levels and with this the heating levels located there above to be automatically lowered.

The invention further includes a combination of the previously described embodiments according to which a furnace formed by separation elements that are vertically stacked on top of one anther and are held in position by an outer frame, wherein the individual separation elements and the heating levels located there between are opened and closed by vertically movable furnace doors.

Within the framework of the invention, frames or rolls can be provided inside the individual heating, levels, which rolls receive the individual sheets or displace the sheets during the heat treatment so that for example damage to the coating of the sheets during the heat treatment is avoided. The heat source can be an electric heat source or a heat source which is operated with fossil fuels. Depending on the type of thermal heat treatment, the heat source can for example be a radiation heat source, an induction heat source or a heat burner. The type of heat source depends on the different temperatures to be reached in the respective heat treatment and on the duration of the performed heat treatment.

Within the framework of the invention, at least one heating level can be closed with a furnace door which can be shifted in vertical direction. According to the invention, this has the advantage that the at least one furnace door which can have a width of 2, 3 or even 4 m, does not have to be supported for pivoting or for pulling out as drawer door or has to be pulled out laterally offset as slide lock, but is shifted in vertical direction for uncovering a furnace slot to the heating level. For this, the furnace door is lifted or lowered vertically. Because the metal components to be heat treated in form of sheets are sometimes only a few centimeters thick, the furnace door only has to be lifted or lowered by a few centimeters. This allows thermally treating sheets with a plate thickness of preferably 1 mm to 100 mm, in particular of 2 to 30 mm and especially preferably plates with a thickness of 3 to 25 mm.

The at least one furnace door can for example be only an opening slot of the layer furnace system, wherein the individual heating levels inside the layer furnace system can be lifted via an actuator and the opening slot is uncovered toward the outside by the vertically displaceable furnace door. Overall, the layer furnace system is thus very well thermally insulated, so that heat can only escape from the furnace system to the environment through the opening slot.

In a further preferred embodiment, the furnace doors of multiple heating levels, particularly preferably all heating levels, for example two furnace doors of two heating levels or three furnace doors of three heating levels are vertically stacked on top of one another, and are linearly guided in a rail system. The furnace doors thus lie in one furnace door surface and are vertically stacked on top of one another. Thus, it is possible to vertically shift the furnace doors or respective individual furnace doors in the linearly guided rail system and to uncover the respective opening slot behind the furnace doors to provide access to the heating level.

Within the framework of the invention, a linear drive is further provided on at least one lateral end of the furnace doors for performing the vertical shifting motion; preferably, a linear drive is provided at each lateral end of the furnace doors. Preferably, the linear drives are arranged on the layer furnace system so that on each side of the furnace doors i.e., on the right side and left side of the layer furnace system, a respective linear drive for all furnace doors is arranged. Thus, all furnace doors are vertically displaceable via these two linear drives.

Within the framework of the invention, the linear drive can be a spindle drive, an electronic actuator or a hydraulic drive. By means of the linear drive it is thus possible, to vertically lift a respective individual furnace door or a furnace door and the furnace doors respectively located there above and with this to uncover the opening slot which lies behind the respective furnace door to provide access to the heating level. Within the framework of the invention, it is also possible by means of the linear drive to lower the furnace doors again after the lifting or instead of lifting the furnace doors from a stating position, to lower them.

Further, the linear drive preferably has engagement means for establishing a form fitting coupling between the linear drive and a respective furnace door. Within the framework of the invention this means that the furnace doors are not permanently connected with the linear drive, but that a coupling between the linear drive and the furnace door to be moved can be generated by the engagement means. In a preferred embodiment of the present invention, the furnace door to be moved is then lifted together with the furnace doors located there above as the case may be, so that the opening slot which lies behind the selected furnace door is uncovered and the heating level can be loaded with a metal component or a metal component can be removed from the heating level. After this, the furnace door and the furnace doors located there above can be lowered again and the form fitting coupling between the engagement means of the linear drive and the furnace door can be released. Within the framework of the invention, the linear drive is then adjustable so that the engagement means can be brought into engagement at another furnace door and this furnace door in particular together with the furnace doors located there above can be lifted and correspondingly lowered again.

Preferably, the engagement means are configured as horizontally slidable handle. Within the framework of the invention, receiving openings for example notches or slots are also located on the sides of the furnace doors, into which notches or slots the slidable handles can be inserted horizontally so that a lifting motion or a lowering motion of the furnace door can be performed, and after completing loading of the heating level, the handles can be detached again from the furnace door. After this, the handles can be moved in vertical direction via the linear drive and another respective furnace door can be selectively actuated.

The handles themselves are displaceable via a horizontally acting linear drive for example an electric actuator, an electromechanical actuator, or a hydraulic or pneumatic actuator. Particularly preferably, the displaceable handles have a safety function, which allows lifting of the furnace doors only after a safe coupling, which furnace doors may be several meters wide and may weigh several hundred kilograms. For example, the safety function can be configured so that after engagement of the handles, a safety signal is first outputted before the linear drive can be further actuated for vertically lifting or lowering the furnace door.

Further preferably, the furnace doors have a brake, so that they remain in the vertical position into which they where moved by the linear drive. The brake can be for example a frictionally locking brake so that by exerting a spring force, a friction force is generated sufficient for retaining the furnace door in the absolute position into which it is moved. Preferably, each furnace door has an individual brake so that it is possible to simultaneously move several furnace doors in vertical direction and all furnace doors then remain in the vertical position. For example, the lowest furnace door of the lifted furnace doors can then be individually lowered via the linear drive, separately from the other furnace doors, wherein all other furnace doors remain in the lifted position due to the respective brake. The brake can for example also be configured in the form of a respective form fitting engagement. For this, a form fitting engagement means arranged on each furnace door engages on a locking toothing for example on a saw tooth profile, and has to be disengaged to enable movement of the respective furnace door.

Further preferably, the furnace doors always lie flat on top of one another due to gravity, wherein lifting a furnace door and the furnace door which in vertical direction lies there above creates an opening slot in front of a heating level for inserting the metal component into the heating level, wherein the lifted furnace door uncovers the opening slot. A metal component can also be removed from the heating level. After this, the opening slot is closed again by lowering the furnace door, and the furnace doors located there above are also lowered. Due to the fact that the furnace doors lie flat on top of one another, all heating levels located there above remain closed during the lifting and lowering process.

Further preferably, the furnace doors are configured thermally insulated and/or the furnace doors are thermally decoupled from the rail system. Within the framework of the invention, the furnace doors are particularly preferably provided with an insulating layer, for example the furnace doors are configured two-layered, wherein an insulating layer which analogous to the functioning principle of Thermopen windows panes is formed between the two layers. Within the framework of the invention, the furnace doors can also have an extra insulating layer made of an insulating material or can be configured multilayered. On one hand, this prevents that temperatures in the furnace interior, which can sometimes be several hundred degree Celsius, can reach the environment via the furnace doors. On the other hand, this prevents that an outer surface which is formed by the furnace doors which lie on top of each other, heats up so that for example a person inadvertently coming into contact with the surface does not suffer burns. Further, the furnace doors are preferably thermally decoupled from the rail system of the linear guide. This also avoids that the heat used in the furnace to heat the metal components dissipates from the furnace doors via the rail system to the environment. This also makes it possible to avoid jamming when moving the furnace doors for example due to different thermal expansions.

Further preferably, a sealing labyrinth for thermal insulation is formed between the furnace doors and the rail system and/or the furnace doors and the separation elements. In a preferred embodiment, the sealing labyrinth has an L-shaped cross section. This impedes the escape of heated air from inside the furnace to the ambient air via the sealing labyrinth. Due to the L-shaped cross section, heat radiation generated within the furnace system cannot dissipate into the environment. However, more complex geometries of the sealing labyrinth are also conceivable within the framework of the invention, for example including additional wave forms or similar geometries. Preferably, a sealing labyrinth is also formed between the furnace doors themselves.

Further preferably, lateral plates are assigned to the separation elements, wherein preferably the furnace doors in conjunction with the side plates thermally insulate the layer furnace system. The side plates can then again preferably be coupled with the vertically configured columns. Within the framework of the invention, the rail system and/or the linear drive can also be coupled with the vertical columns or formed directly in the columns or arranged on the columns. In the case of a defect, it is possible to remove the side plates fast and easily and then lift the separation elements again via a crane to enable installation or maintenance on the defective heating level. Within the framework of the invention, the separation elements are particularly preferably already configured so that they can be stacked on top of one another individually and form a lateral border or sealing of the layer furnace system.

Within the framework of the invention, the layer furnace system can also be constructed as continuous furnace. In this case, furnace doors are formed on a front side and a rear side of the layer furnace system so that a sheet can be inserted on the front side of the layer furnace system and can be removed again at a rear side of the layer furnace system. The sheets can pass through the furnace via a transport system for example a conveyor chain, however, it is also possible to only insert the sheets on the front side and remove them on the rear side without the sheets being transported through the furnace. Within the framework of the invention, the furnace in particular each individual furnace level can also be configured as roller hearth continuous furnace. Also, separation elements for example in the form of grids or plates can be arranged between the individual heating levels into which the metal components to be heat treated are inserted. In this case, the furnace thus has no means for moving the components to be heat treated. The components to be heat treated are for example guided through the furnace by a slider or other loading or handling device. Within the framework of the invention, it is also possible to configure the furnace as drawer furnace, wherein the drawers are then additionally closed at least from one side, in particular from both sides by a vertically movable furnace door, so that the drawer can be pulled out at the front side toward the front side when opening the doors, and can be pulled out at the rear side toward the rear side when closing the doors.

The present invention also includes a method for operating the layer furnace system with at least one of the aforementioned features. For this, an opening slot to a heating level is opened by vertically moving a furnace door.

in a preferred embodiment a furnace door and the furnace door which lie there above in vertical direction are lifted at the height of a heating level for opening the desired heating level and subsequently lowered again form closing the heating level. Within the framework of the invention it is thus possible in case of a plurality of furnace doors for example of 5, 6 or 7 furnace doors to select a middle furnace door for example the 4. furnace door. In the case of 7 furnace doors the 5. 6. and 7. furnace door then lies in vertical direction above the 4. furnace door. When now the 4. furnace door is lifted by the linear drive at the height of essentially one heating level, the 5. 6. and 7. furnace door is automatically lifted along. The 4. furnace door at the same time closes the 5. heating level, the 5. furnace door closes the 6. heating pane and the 6. furnace door closes the 7. heating level, whereas the 7th furnace door is lifted above the 7. heating level. Subsequent to this, the 4. heating level can be loaded through the opening slot with an sheet or an sheet present therein can be removed from the 4. heating level. Subsequent to this, the 4. furnace door is lowered by a linear drive again and the 5. 6. and 7. furnace door located there above is lowered as well due to gravity. In the same way, the 4. heating level is closed by the 4. furnace door, the 5. heating level by the 5. furnace door the 6. heating level by the 6. furnace door and the 7. heating level by the 7. furnace door. During the overall opening process, the 5. 6. and 7. heating levels and the 1. 2. and 3. heating level were always completely closed.

Particularly preferably, sealing elements or sealing labyrinths are formed between the individual furnace doors, so that no heat is lost to the environment via the sealing labyrinths, in particular during the opening or closing process of the furnace doors. In particular when multiple furnace doors which lie on top of each other are lifted together and are guided past heating levels located there behind, no heat escapes between the furnace doors.

Within the framework of the invention, the previously described process of opening a furnace door with 7 heating levels can also be carried out with 10 heating levels, 20 heating levels or even 30 heating levels. For this, any desired furnace door can be opened together with the furnace doors of the heating levels lying there above and lowered again as a result of gravity.

Particularly preferably, for optimally utilizing the range of movement of the linear drive in the method for opening the layer furnace system, in case of an uneven number of furnace doors the uppermost furnace door is actuated first. After the uppermost furnace door is opened, a sheet is inserted into or removed from, the heating level located there behind and the uppermost furnace door is closed again, the next furnace door with an uneven ordinal number is then actuated. In this case, this is the third furnace door from above. After the third furnace door has been opened, in which case the two furnace doors located there above, i.e., the first and the second furnace doors are also opened, and after insertion or removal of a sheet into the third heating level located behind the third furnace door, the third furnace door is closed again, the succeeding uneven furnace door, i.e., the fifth furnace door is actuated and the opening and closing process repeated again. This is continued up to the n-th furnace door.

When the last, i.e., the n-th furnace door has been opened and closed again, the linear drive is positioned at the lowest point of the layer furnace system relative to the vertical direction. Subsequent to this, the second lowest furnace door, i.e. the furnace door corresponding to the ordinal number n−1 is actuated, opened and subsequently closed again. Subsequent to this, all furnace doors with even numbers are successively actuated, opened and subsequently closed so that after opening and closing all even numbered furnace doors, the linear drive is located at the second uppermost point, i.e., at the furnace door with the ordinal number two.

Subsequent to this, the opening and closing process can begin again starting from the first furnace door.

Within the framework of the invention, it is of course also possible to carry out the opening and closing process in inverse direction compared to the above described process. It can thus be started at the lowest, i.e., the n-th furnace door. However, within the framework of the invention, starting at the second uppermost furnace door and proceeding from top to bottom, the even furnace doors can be actuated and subsequent to this the uneven furnace doors.

In case of an even number of n furnace doors, it is further possible for opening within the framework of the invention, to actuate first the uppermost furnace door, i.e., the furnace door with the ordinal number 1, to open and close this furnace door and then actuate the respectively succeeding furnace doors with uneven ordinal number in vertical direction from top to bottom, up to the n−1th furnace door. When the bottommost furnace door with uneven ordinal number, i.e., the n−1th furnace door is actuated, opened and closed, the lowest furnace door with the ordinal number n is subsequently actuated, opened and closed. The bottommost furnace door is lifted together with all furnace doors located there above and is subsequently closed again. As a result, the opening slot to the lowest heating level is uncovered, wherein all heating levels 1 to n−1 located there above remain closed by the furnace doors two to n which are raised in vertical direction. Subsequent to this, all furnace doors with even ordinal numbers located above the bottommost furnace door, are opened and closed from top to bottom. The respective furnace doors which are located in vertical direction above the furnace door to be opened and closed, are lifted and lowered again along with the furnace door to be opened and closed. The method for opening and closing an even number of n furnace doors can be performed in inverse direction from bottom to top and again from top to bottom.

The temporal opening variants offer the advantages that a maximal range of movement over twice a furnace door distance is utilized and optimally adjusted to the process time of the thermal treatment. The furnace can thus be loaded continuously in correspondence with the respective opened heating levels and thermally treated sheets can be removed from the furnace. At the same time, the linear drive is used in a time and cost effective and energy saving manner. In this way, the linear drive does not have to be moved over the entire length of the furnace in order to selectively actuate a furnace door, but it can successively work off the furnace doors of the individual heating levels.

In an alternative embodiment of the present invention, in case of multiple heating levels with respectively corresponding furnace door and a modular furnace construction, one furnace door less is arranged in the layer furnace system, wherein in this case one heating level is always open and by shifting any of the furnace doors upwards or downwards in vertical direction a desired other heating level is opened and the previously described open heating level is closed by shifting. For example, in the case of 10 heating levels, only 9 furnace doors are provided. For this, the furnace doors require an individual brake, so that for example in the case of 10 heating levels the 5. heating level is open. Optionally, for example the furnace door of the 4. heating level can then be lifted in order to close the 5. heating level and to open the 4. heating level or the furnace door of the 6. heating level can be lowered to open the 6. heating level and to close the 5. heating level.

The other furnace doors then always remain in their respective positions, in the same way as the most recently shifted furnace door also remains in its last absolute position. Within the framework of the invention, it is also possible however, for example in the case when the 5. heating level is open, to close the 5. heating level by lifting the furnace door of the 2. heating level and to open the 2. heating level. In this case, the furnace doors of the 3. and 4. heating levels are also lifted by lifting the furnace door of the 2. heating level. The furnace door of the 4. heating level then closes the furnace door of the 5. heating level, the furnace door of the 3. heating level closes the 4. heating level and the furnace door of the 2. heating level closes the 3. heating level. The 2. heating level is then open. Analogous considerations apply to a lowering process.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1a shows a front view of a layer furnace system according to the invention;

FIG. 1b shows a side view the layer furnace system of FIG. 1;

FIG. 2 shows a cross section through a furnace door with side element;

FIG. 3 shows a cross section through three furnace doors stacked on top of each other and

FIG. 4 shows the layer furnace system according to the invention as continuous furnace.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

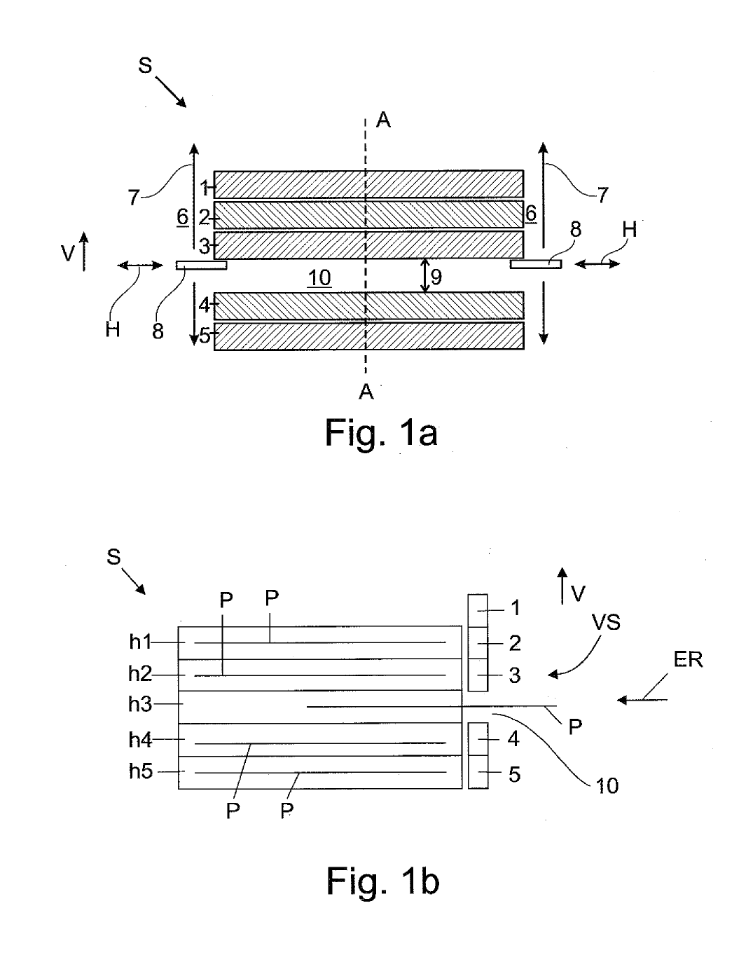

Turning now to the drawing, and in particular to FIG. 1a, there are shown five furnace doors 1, 2, 3, 4, 5, stacked on top of one another which can be shifted in vertical direction V. FIG. 1b shows a cross sectional side view of the layer furnace system taken along the cut line A-A of FIG. 1a. According to FIG. 1b, five heating levels h1 to h5 which are stacked on to of one another, are present in the layer furnace system S, and five furnace doors are present on a front side VS of the layer furnace system S.

In FIG. 1a, a respective linear drive 7 is indicated at the lateral ends 6, wherein the furnace doors 1-5 can be displaced in vertical direction V by adjusting the linear drives 7. In order for the two linear drives 7 to be coupleable with the furnace doors 1-5, the linear drives have engagement means 8, wherein the engagement means 8 can be shifted in horizontal direction H. As shown here, the engagement means 8 are brought to engage on or underneath the furnace door 3 and have lifted the furnace doors 1, 2 and 3 in vertical direction V by the height 9, so that an opening slot 10 in the heating level h3 which is otherwise closed is created. Through the opening slot 10, a sheet P can then be inserted into the heating level h3 in insertion direction ER. In the heating levels h1, h2, h4 and h5 respective sheets P are also inserted and are treated thermally. The heating levels h1 and h2 in the position shown here, are still closed by the furnace doors 2 and 3. After lowering the furnace doors 1 to 3, the heating levels h1 to h5 are then closed again by the furnace doors 1-5.

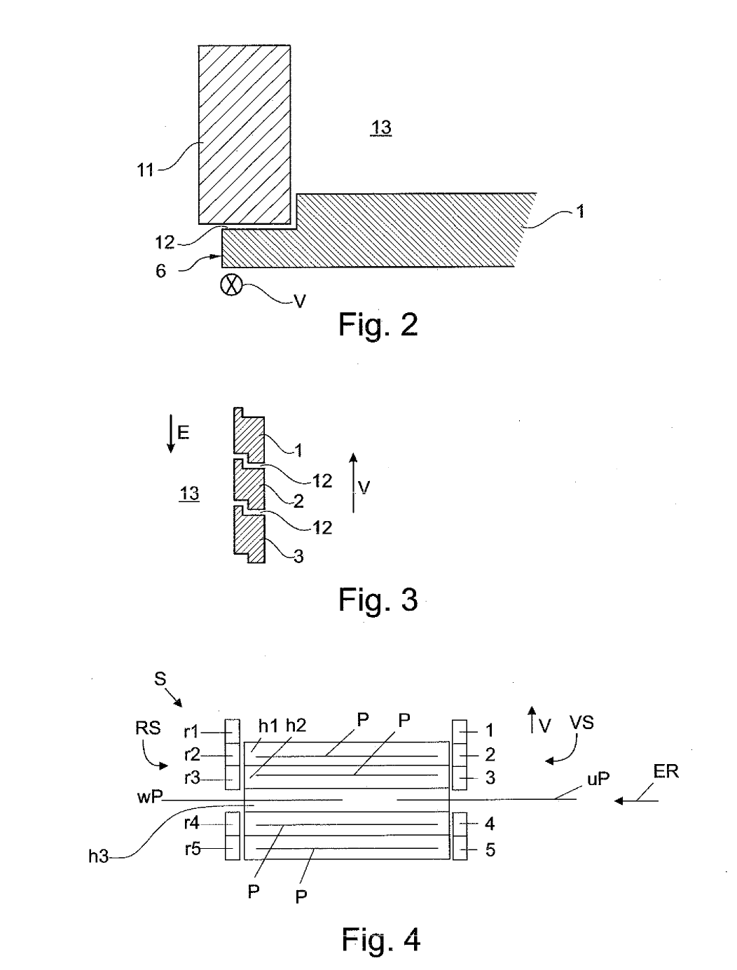

FIG. 2 shows a cross section through a furnace door 1 to 5 with a side element 11. Between the furnace door 1-5 and the side element 11, an L-shaped labyrinth seal 12 is formed, so that hot air inside a heating space 13 can neither escape by convection nor by heat radiation between the furnace door 1-5 and the side element 11. With regard to a shifting in vertical direction V, the furnace door 1-5 can be moved relative to the side element 11, without the labyrinth seal 12 losing its sealing function.

FIG. 3 further shows three furnace doors 1, 2 and 3 which are stacked on top of each other in vertical direction V. Between the individual furnace doors 1-5 respective labyrinth seals 12, here in the form of an inverted L, are formed. Also, the labyrinth seals 12 between the furnace doors 1-3 in vertical directions V prevent that the heat in the heating space 13 escapes from the heating space. When lifting different furnace doors 1-3, for example furnace door 2 and associated therewith furnace door 1 located there above, the labyrinth seal 12 is retained between furnace door 2 and furnace door 1, wherein between furnace door 2 and furnace door 3 an opening slot would be uncovered. After lowering the furnace door 2 and owing to gravity E also the furnace door 1 located there above, the labyrinth seal 12 is again formed between the furnace door 2 and the furnace door 3.

FIG. 4 shows the layer furnace system according to the invention from FIG. 1b, constructed as continuous furnace system, so that the furnace doors 1, 2, 3, 4 and 5 are arranged on the front side VS, wherein on the rear side RS of the layer furnace system S, furnace doors r1-r5 are also arranged. In the variant shown in FIG. 4, the third heating space h3 is uncovered on the front side VS and the rear side r3 by lifting the third furnace door. On the front side, an untreated sheet uP is inserted into the heating room h3 in insertion direction ER and on the rear side RS, a heat treated sheet wP is removed from the heating space h3. Within the framework of the invention, it is also possible to individually open the furnace doors 1-5 on the front side and at the same time keep the furnace doors r1 to r5 on the rear side RS closed and vise versa. The furnace doors on the rear side RS are preferably movable via a linear drive.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A layer furnace system for thermal treatment of metal components, comprising:
plural heating levels arranged on top of one another in vertical direction, and constructed for receiving flat metal components;
at least one heat source; and
at least one furnace door constructed for displacement in vertical direction for opening and closing at least one of the heat levels.

2. The layer furnace system of claim 1, wherein the flat metal components are metal sheets.

3. A layer furnace system for thermal treatment of metal components, comprising:
an outer frame comprising at least two vertical columns;
plural heating levels arranged in the outer frame on top of one another in vertical direction and constructed for receiving flat metal components;
at least one heat source; and
at least one furnace door for closing the heating levels.

4. The layer furnace system of claim 3, wherein the flat metal components are metal sheets.

5. The layer furnace system of claim 1, further comprising plural said at least one furnace door provided for the heating levels in one to one correspondence, said plural furnace doors being arranged vertically on top of one another, and being guided linearly.

6. The layer furnace system of claim 5, further comprising a rail system, wherein the furnace doors are guided linearly in the rail system.

7. The layer furnace system of claim 5, wherein each of the furnace doors has two lateral ends, and wherein the layer furnace system further comprises a linear drive provided on at least one of the two lateral ends for enabling said displacement.

8. The layer furnace system of claim 7, further comprising a second linear drive provided on the other one of the two lateral ends of the furnace doors, for displacing all of the furnace doors via the first and second linear drives.

9. The layer furnace system of claim 7, wherein the linear drive comprises an engagement means, for establishing a form fitting coupling between the linear drive and a respective one of the furnace doors.

10. The layer furnace system of claim 9, wherein the engagement means is configured as horizontally shiftable handle.

11. The layer furnace system of claim 7, wherein the furnace doors are movable by the linear drive to a defined position along the vertical direction, and are provided with a brake, for retaining the furnace doors in the vertical position.

12. The layer furnace system of claim 7, wherein the furnace doors lie flat on top of one another due to gravity and wherein an opening slot is created on a front side of one of the heating levels by lifting one of the furnace doors and further doors arranged above the one furnace door in vertical direction for inserting the metal component into the one heating level.

13. The layer furnace system of claim 5, wherein the furnace doors are configured insulated and/or the furnace doors are thermally decoupled from the rail system.

14. The layer furnace system of claim 5, further comprising a sealing labyrinth formed between the furnace doors and the rail system and/or between two respective vertically adjacent ones of the furnace doors for thermal insulation.

15. The layer furnace system of claim 1, constructed as continuous furnace.

16. The layer furnace system of claim 15, further comprising plural said at least one furnace door provided on a front side and a rear side of the layer furnace system.

17. A method for operating the layer furnace system of claim 16, comprising vertically moving the furnace doors to open a slot to one of the heating levels.

18. The method of claim 17, further comprising lifting one of the furnace doors and further ones of the furnace doors arranged above the one furnace door in vertical direction at a height of one of the heating levels for opening a selected one of the heating levels, and lowering the one furnace door and the further furnace doors for closing the selected heating level.

19. The method of claim 18, wherein the layer furnace system comprises an uneven number of furnace doors, and wherein the vertically moving step comprises actuating the furnace doors in alternating downward vertical succession starting with an uppermost one of the furnace doors, and actuating the furnace doors in alternating upward vertical succession, starting with a second lowest one of the furnace doors.

20. The method of claim 18, wherein the layer furnace system comprises an even number of furnace doors, and wherein the vertically moving step comprises actuating the furnace doors in alternating downward vertical succession starting with an uppermost one of the furnace doors, and actuating the furnace doors in alternating upward vertical succession, starting with a lowest one of the furnace doors.
